(19) United States
(12) Patent Application Publication
(10) Pub. No.: US 2015/0355822 A1
(43) Pub. Date: Dec. 10, 2015

(54) METHOD FOR FINE-TUNING THE PHYSICAL POSITION AND ORIENTATION ON AN ELECTRONIC DEVICE

(71) Applicants: Dougals R. COCHRAN, Novato, CA (US); Kevan CHAPMAN, Novato, CA (US); Robert MAYER, Novato, CA (US); Royal FARROS, Novato, CA (US); IMSI DESIGN, LLC, Novato, CA (US)

(72) Inventors: Douglas R. COCHRAN, Novato, CA (US); Kevan CHAPMAN, Novato, CA (US); Robert MAYER, Novato, CA (US); Royal FARROS, Novato, CA (US)

(21) Appl. No.: 14/435,451

(22) PCT Filed: Oct. 11, 2013
(86) PCT No.: PCT/US13/64699

§ 371 Date: Apr. 13, 2015

Related U.S. Application Data
(60) Provisional application No. 61/712,753, filed on Oct. 11, 2012.

(51) Int. Cl. G06F 3/0484; G06F 3/0481; G06T 11/60; G06T 15/20; G01C 21/20; G01S 19/13

(52) U.S. Cl. CPC G06F 3/04845; G01C 21/206; G01S 19/13; G06T 11/60; G06T 15/205; G06F 3/04815; G06T 2200/04; G06T 2200/24; G06T 2215/16; G06T 2219/2004

(57) ABSTRACT

An electronic data device programmed with a position and orientation calibration and adjustment program to visually display a two- or three-dimensional virtual representation of a user-selected physical space on the electronic visual display and to display a position indicator corresponding to an estimated initial location and orientation of the electronic data device in the user-selected physical space, and thereafter when a user makes a manual adjustment to the indicated location, the program causes the electronic data device to automatically adjust and correct the indicated location.

### BACKGROUND OF THE INVENTION

1. Technical Field

The present invention relates electronic positioning systems generally, and more particularly to a way to augment and fine-tune positions and/or orientations derived from electronic and sensor positioning systems, or data from other knowledge systems, with an actual physical position in a 2D or 3D spatial representation.

2. Background Discussion

All electronic positioning systems, such as but not limited to GPS (Global Positioning System), A-GPS (Assisted Global Positioning System), or WPS (Wi-Fi Positioning System), and SPS (sensor positioning systems), including those that combine data from such instruments as pedometers, accelerometers, gyroscopes, magnetometers, compasses, and the like, have a margin of error. As an example: an architect may be standing in a doorway while looking at an electronic drawing of the building floor plan on an electronic device, but the electronic positioning system may place that person in a wall a considerable distance away from the doorway where he or she is actually standing. That is, there is a discrepancy in the device indication between the world coordinate system and the electronic drawing coordinate system, typically due to calibration error.

It would be helpful to more accurately display an actual physical position calibrated in a 2D or 3D spatial representation on an electronic device by correcting for calibration error and to fine-tune position and/or orientation calculations. The present invention provides such a solution using data from electronic and/or sensor positioning systems, and/or from other knowledge systems such as Building Information Modeling data, combined with the ability to display a spatial representation and indicate on that display through manual input an actual position.

### DISCLOSURE OF INVENTION

The present invention provides a system and method for fine-tuning the position of a user's electronic device on a virtual map of the interior (and optionally, the exterior) of a building or other location. The user can manually adjust the virtual position of the device on the virtual map of the interior of the building or of some other physical location. The user is enabled to manually move the device location, and reorient the device on the presented virtual map. This feature is used to compensate for differences between the device's location as determined by an automatic location-determination system operating in and/or with the device and the actual physical location of the device as determined by the user. This is useful in that it makes it easy for a user (such as a building inspector) to manually correct the actual geographic position of the device within the building, thus allowing the software of the inventive system to recalibrate its own position, and thereafter to use the location offset to reposition other existing location tags or map features (walls, stairwells, etc.), as necessary, on the virtual map of the building in relation to where the user of the device is now indicated to be located.

The novel features characteristic of the invention will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure.

### BRIEF DESCRIPTION OF THE DRAWINGS

The invention and its various objects and advantages will be understood when consideration is given to the following detailed description thereof. Such description makes reference to the annexed drawings wherein:

FIG. 1 is a highly schematic block diagram showing the operational elements of an electronic device for operating the system of the present invention;

FIG. 2 is one of many possible schematic examples of a display shown on the type of electronic device in FIG. 1 showing a representation of a physical space (a floor plan) that, in this situation, includes an original location point and orientation derived from data from an electronic positioning system;

FIG. 3 is schematic example showing the same display after position and orientation fine-tuning is complete, with a sample representation of one of many ways to depict current device position and/or orientation on the display;

FIG. 4 is a block diagrammatic flow diagram showing the method steps employed by the system of the present invention;

FIG. 5A is the first of five schematic views showing screen shots of changes in a device display as a user interacts with the device to correct an inaccurately indicated initial location and orientation of the device, this first figure showing a position indicator depicting the user start position on a schematically displayed floor plan;

FIG. 5B is a schematic view showing one way in which a user may engage the position indicator in the user interface to correct an observed error in the displayed initial location, and further showing an orientation marker and orientation grid;

FIG. 5C shows how the user may move the position indicator from the inaccurate initially displayed location to the correct location, with corresponding movements of the orientation marker and grid;

FIG. 5D shows how the user may engage the user interface to correct the inaccurate initially indicated orientation; and

FIG. 5E shows the system display after the system has applied a coordinate transform to recalibrate the device position and displays a corrected position indicator location as well as a corrected orientation.

### BEST MODE FOR CARRYING OUT THE INVENTION

The present invention is a software-mediated, computer-implemented method for fine-tuning an electronic device's current physical position and/or orientation on the display of an electronic device with or without assistance from other forms of electronic and sensor positioning systems or data from other knowledge systems. The inventive system includes a set of programmatic routines (a computer-executable program) operated on an electronic device. The invention includes methods to manually drag the position indicator to correct and fine-tune a location and/or orientation and to mathematically calculate and store the resulting offset. The inventive system may or may not be used to geolocate a non-geolocated document or be included as part of a larger program or suite of programs that contain additional features beyond those described.

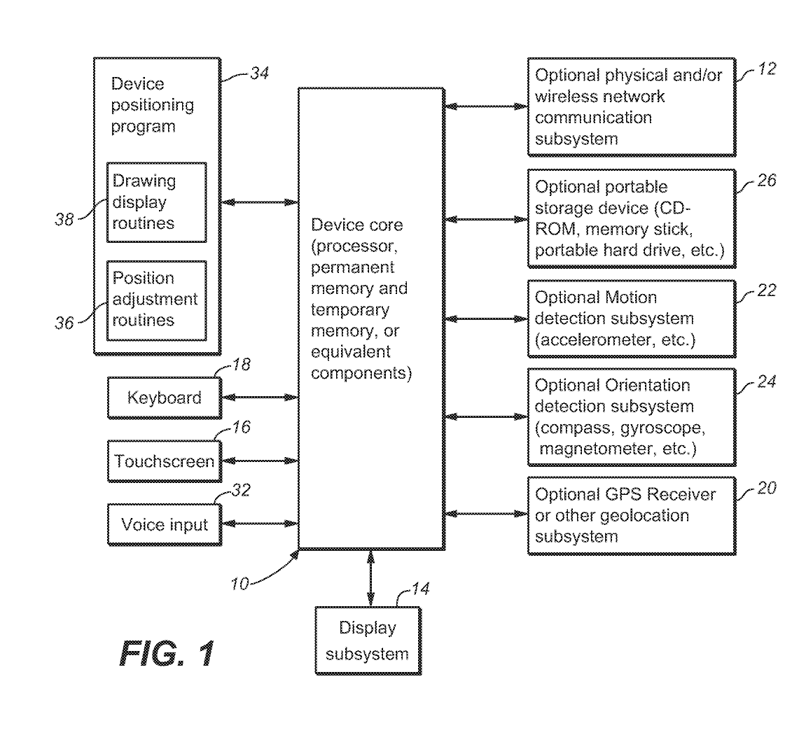

Referring now to FIG. 1, a block diagram is shown illustrating an embodiment of an electronic data device 10 suitable for use in the present invention, the device including a core processor, permanent memory for storing a program in a computer-readable medium, and temporary memory or functional equivalents for loading and running a program, also in a computer-readable medium. The device may include a variety of further features and inputs, but essential components in addition to the processor and permanent and temporary memory include, at least: means to load a computer-executable program onto the device, possibly by a physical or wireless network communications subsystem 12 or some form of removable computer-readable media 26 (such as a CD-ROM, memory stick, portable hard drive, and the like); a display subsystem 14; a touchscreen 16, a keyboard 18, a voice input 32, or other means of interacting with the program. The loaded program includes computer-executable instructions that are executed on the electronic data device, and the graphical user interface and program output is presented on the display subsystem 14.

Optional components may include a GPS receiver or other geolocation subsystem 20, such as but not limited to GPS, A-GPS, or WPS; a motion and/or rotation detection subsystem 22, employing one or more motion and/or rotation sensors, such as a pedometer, accelerometer, or the like, and possibly in combination; an orientation detection subsystem 24, using one or more orientation sensors such as, but not limited to, a compass, gyroscope, magnetometer, or the like, also possibly in combination.

There are many ways to use the program. One such way is physically locating the electronic device 10 at the physical site where the device positioning program 34 is loaded or initiated and a spatial representation is selected and displayed by the display system 14. An initial position and/or orientation is derived from an optional GPS receiver or other geolocation subsystem 20, such as but not limited to GPS, A-GPS, or WPS; and/or from motion detection data from an optional motion detection subsystem 22, such as a pedometer, accelerometer, and so forth; and/or from electronic sensor positioning system data from an optional orientation detection subsystem 24, using data, such as but not limited to compass, gyroscope, magnetometer, and so forth; and/or from data gathered from a knowledge system, such as, but not limited to, Building Information Modeling.

The program further includes a position adjustment routine 36 and a drawing display routine 38, which each utilize the display subsystem 14.

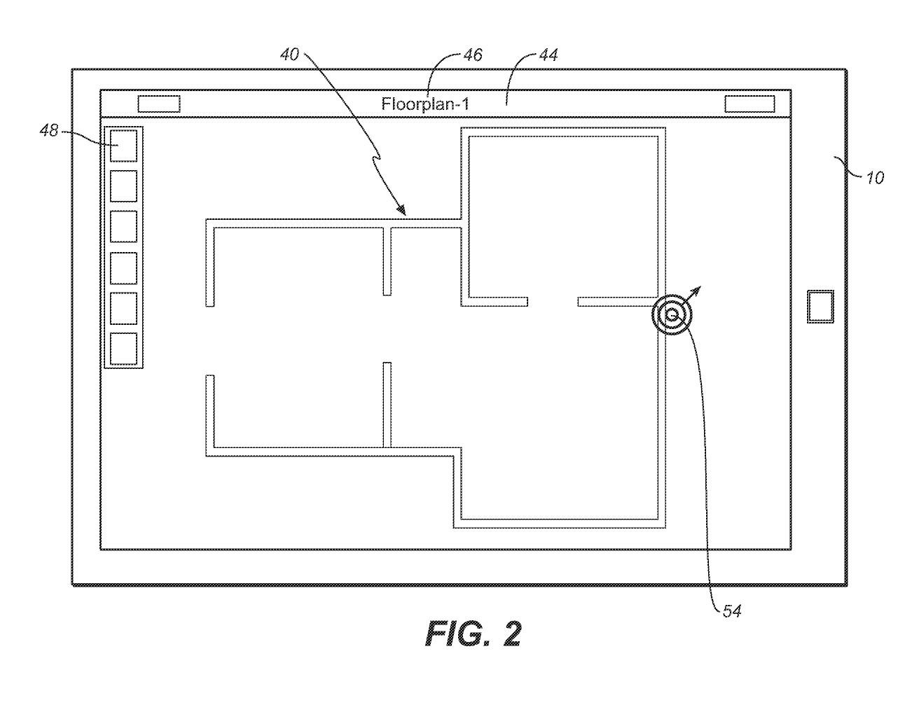

FIG. 2 shows the electronic device 10, with a sample drawing plan 40 shown on the display surface 42. A sample representation of a typical user interface 48 provides a means of fine-tuning position and/or orientation. The displayed position and/or orientation 54 can be manually fine-tuned by simply dragging the position indicator to the desired location and/or orientation on the displayed representation. The fine-tuned position and/or orientation will result in a positional and/or rotational offset calculated and stored by the position adjustment routine, and that offset may or may not be used in future position determinations.

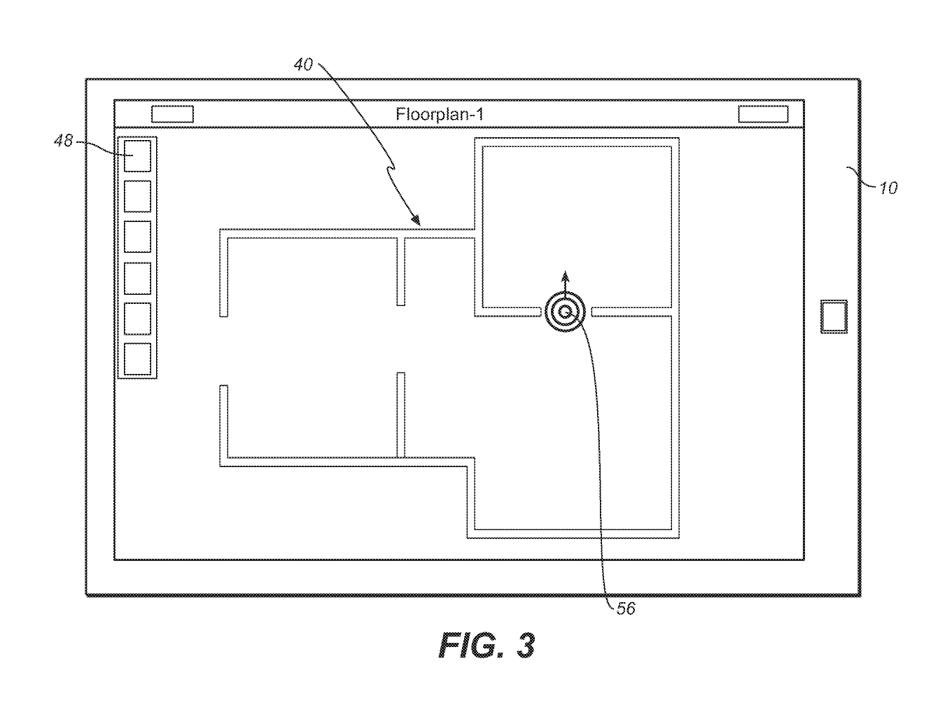

FIG. 3 shows the same device 10 and electronic drawing plan 40 after fine-tuning has been completed. The device's fine-tuned location and orientation are shown on the electronic drawing by sample position indicator 56.

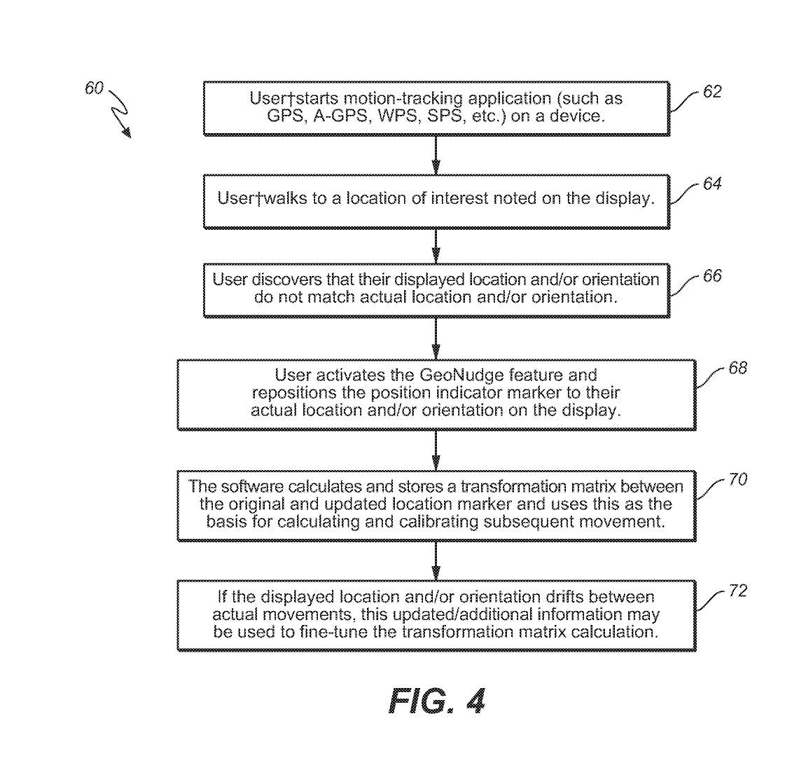

FIG. 4 is a flow chart 60 showing the method steps employed by the system of the present invention. Commencing use of the inventive system, a user starts a motion-tracking application 62 (such as GPS, A-GPS, WPS, SPS, etc.) on a device. The user next moves 64 to a location of interest noted on the display. At that point the user may discover 66 that the displayed location and/or orientation do not match actual location and/or orientation. If that is the case, the user then activates 68 the position/orientation recalibration feature and repositions the position indicator marker to the observed actual location and/or orientation on the display. The system software then calculates and stores 70 a transformation matrix between the original and updated location marker and uses this as the basis for calculating and calibrating subsequent movement. If the displayed location and/or orientation drifts or changes between actual movements, this updated/additional information may be used to adjust and fine-tune 72 the transformation matrix calculation.

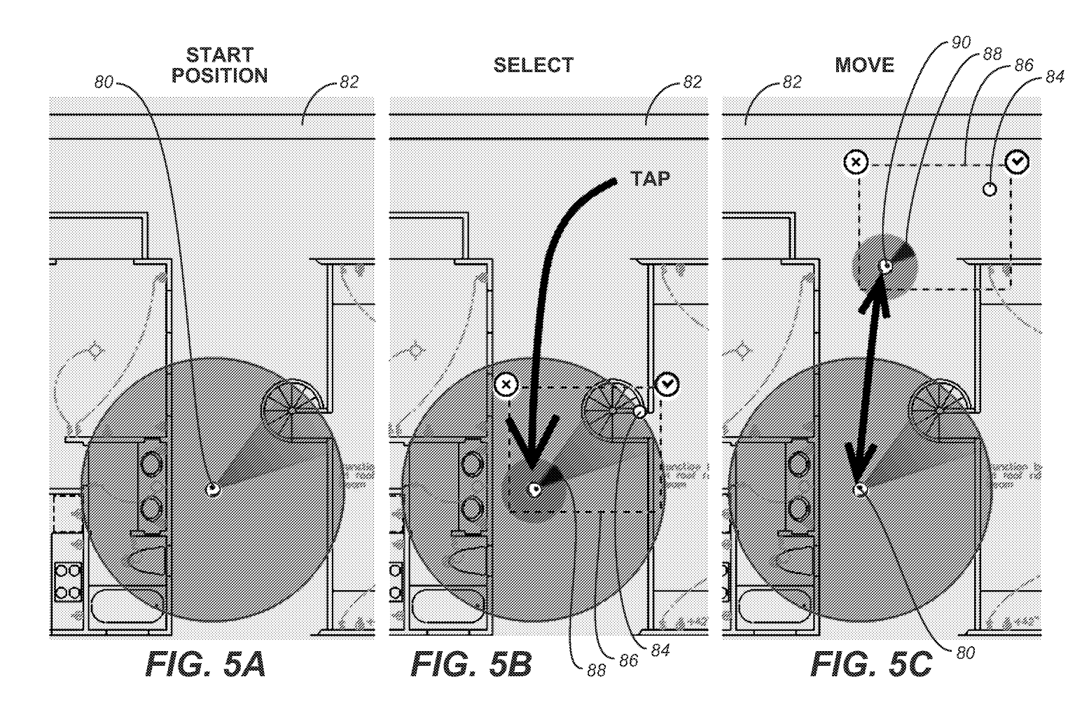

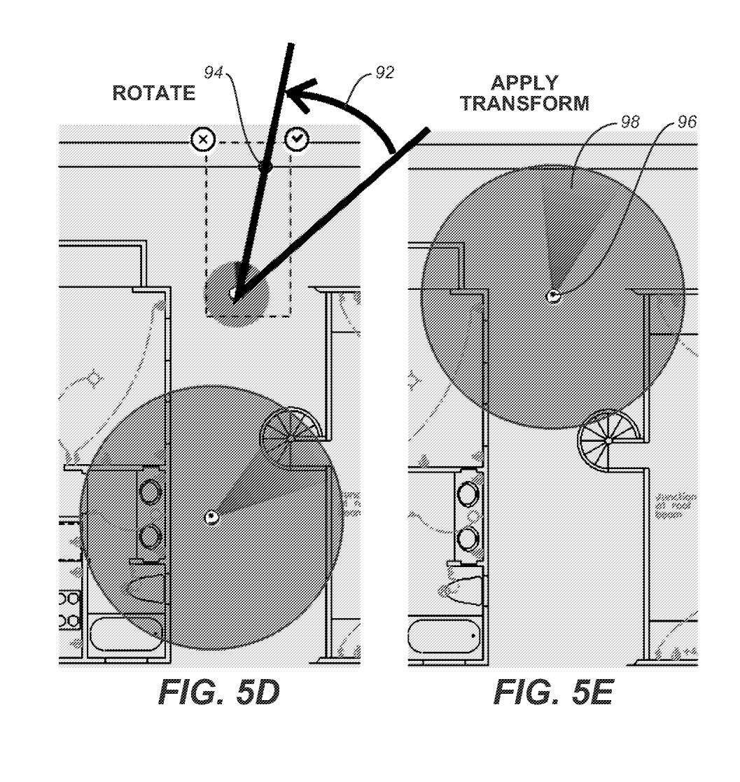

FIGS. 5A through 5E are schematic views showing screen shots of a sample electronic device display as position and orientation corrections are applied by a user and calculated by the inventive system. In FIG. 5A, there is shown the position indicator 80 depicting the user start position on a schematically displayed floor plan 82. When the user observes an error in the displayed location, he or she taps the position indicator 80, FIG. 5B. An orientation marker 84 and orientation grid 86 are optionally displayed, with an orientation sector 88 describing an arc within which the device is generally pointed. Next, the user moves the position indicator from the inaccurate location to the correct location 90, FIG. 5C, wherein the orientation grid 86 and sector 88 are correspondingly moved. If the orientation indicated is also inaccurate, the user taps the orientation marker 84, FIG. 5D, to correct the indicated orientation indication, which action also moves the orientation marker 84 and sweeps it through an arc 92 to establish a corrected orientation bearing 94 or direction of observation. The system then applies a transform to recalibrate the position and to display a corrected position indicator 96 as well as a corrected orientation sector 98 in which the corrected orientation bearing is generally centered, as shown in FIG. 5E.

In the most summary and essential terms, system algorithms operate as follows: an initial position point is defined in the electronic device drawing coordinate system corresponding to the estimated physical coordinates calculated by data from whatever on-board motion/position tracking system is employed. An initial device target direction or orientation is also established in the device drawing coordinate system as calculated by the tracking system.

The user may adjust the placement of the position indicator on the device display to correct an inaccurate representation of his physical location. When he or she does so, the device calculates the offset in drawing coordinates between the original and corrected position points, and executes one or more transformations (e.g. a linear transformation) to determine the corresponding physical coordinates as well as the offset between the originally estimated and corrected physical coordinates.

The user may additionally or separately adjust the orientation of the position indicator on the device display to correct an inaccurate representation of his current orientation. When he or she does so, the device calculates the offset in drawing coordinates between the original and corrected orientation, and executes one or more transformations (e.g. a linear transformation) to determine the corresponding physical orientation as well as the difference between the originally estimated and corrected physical orientation.

The newly-adjusted physical coordinates and orientation are used as the reference points for further motion tracking. The differences between the estimated and corrected position and orientation may or may not be stored for later use in refining the motion tracking algorithm.

A possible (exemplary) mathematical approach for the recalibration algorithm employed when a user observes an error in the location displayed, selects the displayed position indicator, moves it to the correct location on the display, and (optionally) changes the direction (orientation), is set out as follows:

$${X}_{currentInDrawing} = ( \begin{matrix}x \\ y \\ z \\ 1\end{matrix} ) - the point that defines the position indicator position in the drawing ’ s coordinate system . \\ {X}_{targetInDrawing} = ( \begin{matrix}x \\ y \\ z \\ 1\end{matrix} ) - the point that defines the position indicator ’ s direc t ion ( target ) in drawing ’ s coordinate system . \\ {X}_{currentInWorld} = ( \begin{matrix}x \\ y \\ z \\ 1\end{matrix} ) - point that defines the position indicator position in the world coordinate system . \\ {X}_{targetInWorld} = ( \begin{matrix}x \\ y \\ z \\ 1\end{matrix} ) - point that defines the position indicator ’ s direc t ion ( target ) in the world coordinate system . \\ {M}_{current} = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) - current transformation matrix . \\ {X}_{currentInDrawing} = {M}_{current} * {X}_{currentInWorld} \\ {X}_{newInDrawing} = ( \begin{matrix}x \\ y \\ z \\ 1\end{matrix} ) - new position indicator position in drawing coordinate system . \\ {X}_{newInWorld} = ( \begin{matrix}x \\ y \\ z \\ 1\end{matrix} ) - new position indicator position in world coordinate system . \\ {M}_{new} = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) - new transformation matrix . \\ {X}_{newInDrawing} = {M}_{new} * {X}_{newInWorld}$$

The mathematics employed to calculate the rotation and offset matrix for the position indicator are set out as follows:

$${D}_{offset} = ( \begin{matrix}Dx \\ Dy \\ Dz \\ 1\end{matrix} )$$

$${M}_{offset} = ( \begin{matrix}1 & 0 & 0 & 0 \\ 0 & 1 & 0 & 0 \\ 0 & 0 & 1 & 0 \\ Dx & Dy & Dz & 1\end{matrix} )$$

$${M}_{rotation} = ( \begin{matrix}cos ( a ) & sin ( a ) & 0 & 0 \\ - sin ( a ) & cos ( a ) & 0 & 0 \\ 0 & 0 & 1 & 0 \\ 0 & 0 & 0 & 1\end{matrix} )$$

Finally, the mathematics employed to calculate the rotation angle and offset for the position indicator are as follows:

D_{offset}=X_{new}−X_{old}

a_{current}=OX̂(X_{current}−X_{currentTarget})

a_{new}=OX̂(X_{new}−X_{newTarget})

a=a_{new}−a_{current}

In the result there are express M_{new} by M_{current}·M_{new}=M_{current}*Mᵣₒₜₐₜᵢₒₙ*M_{offset}

The foregoing disclosure is sufficient to enable those with skill in the relevant art to practice the invention without undue experimentation. The disclosure further provides the best mode of practicing the invention now contemplated by the inventors.

What is claimed as invention is:

1. A method of fine-tuning the indication of the physical location and orientation of an electronic data device in a physical space, comprising:
(a) providing an electronic data device having a core processor, permanent memory for storing a program, temporary memory for loading and running a computer-executable program, means to load a computer-executable program onto the electronic data device, an electronic visual display, a visual display subsystem, at least one user input means for interacting with a computer-executable program, and a motion and/or rotation detection subsystem;
(b) moving the electronic data device in a physical space;
(c) loading a position and orientation calibration program with a device drawing coordinate system onto the electronic data device, which, when executed by the electronic data device, causes the device to visually display a two- or three-dimensional virtual representation of a physical space on the electronic visual display and an estimated initial location and orientation of the electronic data device in the physical space, and thereafter to update and correct the location according to user inputs;
(d) initiating execution of the position and orientation calibration program;
(e) defining an initial location point in the electronic device drawing coordinate system corresponding to the estimated initial location and orientation;
(f) displaying on the electronic visual display a visual position indicator to indicate the initially estimated location and orientation; and
(g) manually adjusting the placement of the position indicator on the device display to correct any observed inaccurate representation of the electronic data device physical location;
wherein the position and orientation calibration program calculates an offset in drawing coordinates between the initial and corrected position points, and executes one or more transformations to determine the corresponding physical coordinates as well as the offset between the initially estimated location and orientation and the physical coordinates of the corrected location.

2. The method of claim 1, further including adjusting the orientation of the visual position indicator on the electronic data device electronic visual display to correct an inaccurate representation of the displayed orientation.

3. The method of claim 2, further including using the position and orientation calibration program to calculate the offset in drawing coordinates between the initially estimated and corrected orientation, and executing one or more transformations to determine the corresponding physical orientation as well as the difference between the initially estimated and corrected physical orientation.

4. The method of claim 3, further including using the adjusted physical orientation as a reference point for further motion and orientation tracking.

5. The method of claim 3, further including storing differences between the initially estimated location and the corrected location for later use in refining the motion tracking algorithm.

6. The method of claim 1, further including using the position and calibration program to calculate the offset in drawing coordinates between the initially estimated and corrected location, and executing one or more transformations to determine the corresponding physical location as well as the difference between the initially estimated and corrected physical location.

7. The method of claim 6, further including using the adjusted physical orientation as a reference point for further motion and orientation tracking.

8. The method of claim 6, further including storing differences between the initially estimated location and the corrected location for later use in refining the motion tracking algorithm.

9. The method of claim 1, wherein the electronic data device includes at least one location tracking system and the initially estimated location is calculated by data from the location tracking system.

10. The method of claim 1, wherein the user input device includes at least one or more of a touchscreen, a keyboard, and a voice input.

11. The method of claim 1, wherein the electronic data device includes a geolocation subsystem, and wherein step (c) includes using data from the geolocation subsystem to calculate the estimated initial location.

12. The method of claim 1, wherein the electronic data device includes a geolocation subsystem, and wherein step (c) includes using data from the geolocation subsystem to calculate the estimated initial orientation.

13. The method of claim 11, wherein the geolocation subsystem includes at least one or more of a GPS, A-GPS, and WPS system.

14. The method of claim 1, wherein the motion and rotation detection subsystem includes at least one motion and/or rotation sensor includes any of a pedometer, an accelerometer, a compass, a gyroscope, and a magnetometer, alone or in any combination.

15. The method of claim 14, wherein step (c) includes using data from the motion and rotation subsystem to calculate the estimated initial location.

16. The method of claim 1, wherein step (c) includes using data from the motion and rotation subsystem to calculate the estimated initial location.

17. A system, comprising:
an electronic data device having a core processor, a permanent memory for storing a computer-executable program, temporary memory or functional equivalents for loading and running a program, program loading means, an electronic visual display, a display subsystem, at least one user input device for interacting with an executable program, and a motion and rotation detection subsystem; and
a computer-readable medium including a position and orientation calibration and adjustment program with instructions that, when executed by said core processor cause said electronic data device to visually display a two- or three-dimensional virtual representation of a user-selected physical space on the electronic visual display and to display a position indicator corresponding to an estimated initial location and orientation of the electronic data device in the user-selected physical space, and thereafter to adjust and correct the location according to user manual inputs.

18. The system of claim 17, wherein said computer-readable medium further includes instructions that, when executed by said core processor, causes said electronic data device to define an initial location point in the electronic device drawing coordinate system corresponding to the estimated initial location and orientation of said electronic data device, and further, in response to a user manually adjusting the placement of the position indicator on the device display to correct any observed inaccurate representation of the electronic data device physical location, to calculate an offset in drawing coordinates between estimated initial and user-corrected location points, and execute one or more transformations to determine the corresponding physical coordinates as well as the offset between the initially estimated location and orientation and the physical coordinates of the user-corrected location.

19. The system of claim 18, wherein said computer-readable medium further includes instructions that, when executed by said core processor, causes said electronic data device to calculate the offset in drawing coordinates between the initially estimated and corrected orientation, and to execute one or more transformations to determine the corresponding physical orientation as well as the difference between the initially estimated and corrected physical orientation.

20. The system of claim 17, wherein said at least one user input device includes at least one or more of a touchscreen, a keyboard, and a voice input.

21. The system of claim 17, wherein said program loading means includes at least one or more of a physical or wireless network communications subsystem, CD-ROM, memory stick, and portable hard drive, alone or in any combination.

21. The system of claim 17, further including a geolocation subsystem.

22. The system of claim 21, wherein said geolocation subsystem includes at least one or more of GPS, A-GPS, or a WPS system, alone or in any combination.

23. The system of claim 21, wherein said motion and rotation detection subsystem includes one or more motion and rotation sensors.

24. The system of claim 23, wherein said motion and rotation sensors includes at least one or more of a pedometer, an accelerometer, a compass, a gyroscope, a magnetometer, alone or in any combination.

25. The system of claim 17, wherein said processor is programmed to use a transformation matrix to adjust for changes in the displayed location and/or orientation between actual movements of the electronic data device.

26. The system of claim 17, wherein said processor is programmed to display a position indicator on a touchscreen which depicts a user start position on a schematically displayed site plan, and wherein when the user observes an error in the displayed location, he or she can tap the position indicator and move the position indicator from the inaccurate location to a correct location, and wherein said system then applies a transform to recalibrate the position and to display a corrected position indicator.
